(19) United States
(12) Patent Application Publication
(10) Pub. No.: US 2019/0239508 A1
(43) Pub. Date: Aug. 8, 2019

(54) VINEGAR BASED ANTI-BACTERIAL AGENT

(71) Applicant: Gokulakrishnan Sankar, Arlington, TX (US)

(72) Inventor: Gokulakrishnan Sankar, Arlington, TX (US)

(21) Appl. No.: 16/266,034

(22) Filed: Feb. 2, 2019

Related U.S. Application Data
(60) Provisional application No. 62/625,509, filed on Feb. 2, 2018.

(51) Int. Cl. A01N 37/02; A01N 25/04

(52) U.S. Cl. CPC A01N 37/02; A01N 25/04

(57) ABSTRACT

A vinegar based anti-bacterial agent is a safe solution to harmful chemicals used to remove bacteria from skin, food or other objects. The use of vinegar enables the agent to be ingested without harmful effects.

### BACKGROUND

### 1. Field of the Invention

The present invention relates generally to cleaning systems, and more specifically, to a compounds, mixtures or solutions for eliminating bacteria, viruses or other harmful organisms from surfaces or objects.

### 2. Description of Related Art

Cleaning systems are well known in the art and are effective means to remove inanimate, living or other types of matter from objects or surfaces where they are not desired. For example, conventional antibacterial solutions use triclosan, triclocarban or chloroxylenol to remove bacteria where they are applied. These chemicals have known health risks for humans as they can be absorbed through the skin, consumed when not fully removed from what they were applied to or from consumption of plant or animals who are exposed to waste water.

Accordingly, although great strides have been made in the area of antibacterial solutions, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is diagram of a vinegar based anti-bacterial agent in accordance with a preferred embodiment of the present application.

While the agent and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the agent and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The agent and method of use in accordance with the present application overcomes one or more of the above-discussed problems commonly associated with conventional antibacterial solutions. Specifically, invention of the present application eliminates or reduces bacteria without harming unintended consumers such as humans, animals or plants. These and other unique features of the agent and method of use are discussed below and illustrated in the accompanying drawings.

The agent and method of use will be understood, both as to its structure and operation, from the accompanying drawings, taken in conjunction with the accompanying description. Several embodiments of the agent are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

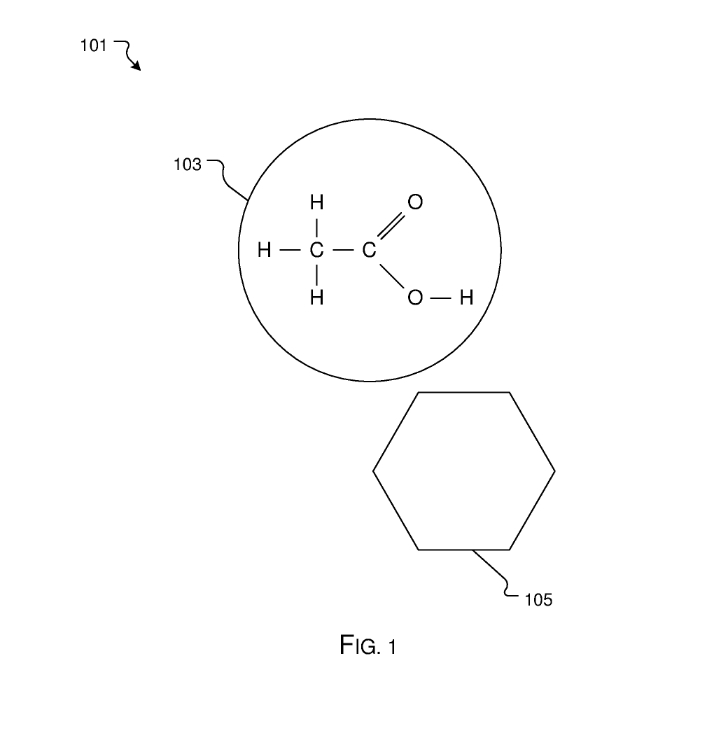

Referring now to the drawings wherein like reference characters identify corresponding or similar elements throughout the several views, FIG. 1 depicts a diagram of a vinegar based anti-bacterial agent in accordance with a preferred embodiment of the present application. It will be appreciated that agent 101 overcomes one or more of the above-listed problems commonly associated with conventional anti-bacterial solutions.

In the contemplated embodiment, agent 101 includes vinegar molecules 103 intermixed with an emulsifying compound 105.

It should be appreciated that one of the unique features believed characteristic of the present application is that the vinegar molecules 203 are safe for consumption reducing or eliminating the negative effects of conventional anti-bacterial solutions.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A vinegar based anti-bacterial agent comprising vinegar molecules mixed with an emulsifying compound.
